(19) United States
(12) Patent Application Publication
(10) Pub. No.: US 2002/0181779 A1
(43) Pub. Date: Dec. 5, 2002

(54) Character and style recognition of scanned text

(76) Inventor: Von L. Hansen, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/874,187

(22) Filed: Jun. 4, 2001

(51) Int. Cl. G06K 9/62

(52) U.S. Cl. 382/209

(57) ABSTRACT

A method of determining style characteristics from scanned data includes identifying characters within the scanned data. The characters are then compared to a style library containing templates of each style characteristic to determine the style characteristics for each character. The scanned data is saved as processed data containing style characteristics of the scanned data. An information sheet containing the style characteristics of the scanned data can be printed or the style characteristics can be set as formatted text, along with the processed data, to be readable by a word processing program.

### BACKGROUND OF THE INVENTION

1. Field of the Invention

The present invention relates generally to the scanning and capturing of data and, more particularly, to the processing of the data to recognize the character and style formats of text within the data.

2. Related Art

A scanner is a device that scans or photographs an object, such as a printed page, and converts the scanned image into a graphics image for storage in memory and later use by a computer. A typical scanner employs an optical source and a charge-coupled device to record the image as a bitmap, which is a binary representation where one or more bits corresponds to some part of the image.

One drawback of a conventional scanner is that it does not recognize the content of the data that it is scanning. All of the captured data is simply converted to a bitmap whether the data consists, for example, of text (e.g., text or characters) or graphics. Software programs exist that attempt to recognize the text within the bitmap. For example, optical character recognition (OCR) software analyzes the bitmap in order to identify text, such as alphabetic letters or numeric digits. When a character is identified, the OCR software converts the character into binary coded text, such as ASCII (American Standard Code for Information Interchange) code or EBCDIC (Extended Binary Coded Decimal Interchange Code).

The application of OCR software to a bitmap representation of scanned text provides significant savings in terms of memory space. For example, one page of scanned text in bitmap form may require 100 Kilobits of memory to store while the same page of scanned text after processing by OCR software may require only 2 Kilobits. However, a drawback of conventional OCR software is that during the translation from bitmap to coded text (e.g., ASCII), the style characteristics of the scanned text are lost. For example, the particular font characteristics of the scanned text are lost, requiring the user to manually search for and apply the correct font to the scanned text. This task is time-consuming and may be required for all forms of style characteristics, including format, of the scanned document and text.

Furthermore, if additional text must be added to the scanned data and the user desires to continue with the same style characteristics as the document that was scanned, the style settings must first be determined and manually set by the user prior to the insertion of additional text. As a result, there is a need for a system and method of scanning data that not only recognizes textual data, but also automatically recognizes and applies the style characteristics.

### BRIEF SUMMARY OF THE INVENTION

In accordance with embodiments of the present invention, systems and methods are provided for scanning data and automatically recognizing not only text but also style characteristics of the scanned data. These characteristics can then be applied and set in a word processing program, for example. If additional text is added or inserted, this text will have the same style characteristics as the text of the scanned document.

In accordance with one embodiment, a method of determining style characteristics from scanned data includes identifying characters within the scanned data; comparing the characters to a style library containing templates of each style characteristic to determine the style characteristics for each character; and saving the scanned data as processed data containing style characteristics of the scanned data.

In accordance with another embodiment, a computer system for processing scanned data includes a processor and a memory, coupled to the processor, storing instructions that are executed by the processor to perform a method of processing the scanned data. The method including identifying characters within the scanned data; comparing the characters to templates of each style characteristic to determine style characteristics for each character; and saving in the memory the scanned data as processed data containing the style characteristics of the scanned data.

In accordance with yet another embodiment, a machine-readable medium for use in a computer system having a processor for processing scanned data, the medium having instructions that are executed by the processor to perform a method of processing the scanned data. The method includes identifying characters within the scanned data; comparing the characters to templates of each style characteristic to determine style characteristics for each character; and saving the scanned data as processed data containing the style characteristics of the scanned data.

A more complete understanding of the present invention will be afforded to those skilled in the art, as well as a realization of additional advantages thereof, by a consideration of the following detailed description of one or more embodiments. Reference will be made to the drawings that will first be described briefly.

### BRIEF DESCRIPTION OF THE DRAWINGS

FIG. 1 is a block diagram illustrating a computer system that includes a scanner, in accordance with an embodiment of the present invention.

FIG. 2 is a block diagram illustrating a scanning system, in accordance with an embodiment of the present invention.

FIG. 3 is an exemplary document illustrating portions of text having various styles, in accordance with an embodiment of the present invention.

FIG. 4 is a flowchart illustrating the steps for scanning data and recognizing text and style characteristics, in accordance with an embodiment of the present invention.

The various exemplary embodiments of the present invention and their advantages are best understood by referring to the detailed description that follows. It should be understood that exemplary embodiments are described herein, but that these embodiments are not limiting and that numerous modifications and variations are possible in accordance with the principles of the present invention. In the drawings, like reference numerals are used to identify like elements illustrated in one or more of the figures.

### DETAILED DESCRIPTION OF THE INVENTION

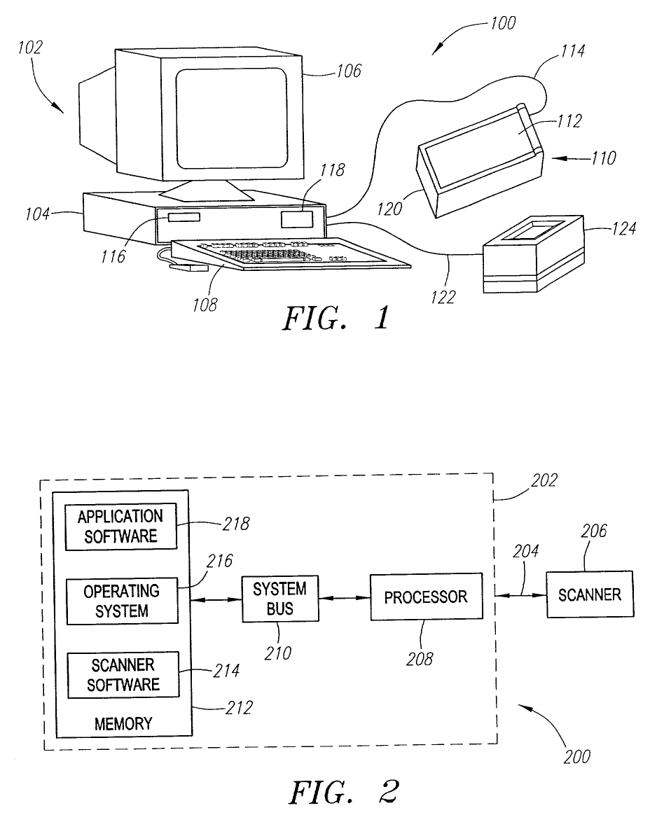

FIG. 1 is a block diagram illustrating a computer system 100, in accordance with an embodiment of the present invention. Computer system 100 includes a computer 102, a scanner 110, interfaces 114 and 122, and a printer 124. Computer 102 is shown as having a main unit 104, a monitor 106, and a keyboard 108. Main unit 104 houses the computer electronics (not shown), such as a central processing unit and memory, and provides for devices, such as a floppy disk drive 116 and a compact disk drive 118. Floppy disk drive 116 and compact disk drive 118 are used to read portable storage media (e.g., a floppy disk or a compact disk, respectively). Monitor 106 is a display screen that is used to present output from computer 102, while keyboard 108 contains input keys for entering information into computer 102.

Computer 102 is coupled to scanner 110 through interface 114 and to printer 124 through interface 122. Interfaces 114 and 122 may comprise part of a computer network that is used to carry information between computer 102, scanner 110, and printer 124, or may comprise individual hardware interfaces between the devices. For example, interface 114 and interface 122 may each be a universal serial bus (USB) and routed through a USB hub (not shown).

Scanner 110 includes a main housing 120 and a cover 112. Cover 112 rotates away from main housing 120 to scan an object, such as a document containing text, which is placed between main housing 120 and cover 112. Scanner 110 can then read or scan the document and convert the scanned information into a graphics image, such as a bitmap, which can then be stored in memory of scanner 110 or in memory of computer 102 by transferring the information through interface 114. Printer 124 prints the scanned data or a style sheet resulting from the analysis of the scanned data, as discussed further herein.

It should be understood that computer system 100 is an exemplary representation of a scanner within a computer system and that the present invention is not limited to this exemplary representation. For example, scanner 110 represents a flatbed scanner, but any type of device that scans objects may be utilized by the present invention. Furthermore, the scanning device employed may be a stand-alone and not require computer 102 or interface 114, but instead simply scan and store the data for later retrieval through a temporary interface or portable storage device, such as a floppy disk, or print the results by incorporating printing capabilities. The scanning device may further include a processor to execute a program to recognize the characters and style of the scanned information, as discussed herein, or may be incorporated as part of computer 102.

FIG. 2 is a block diagram illustrating a scanning system 200, in accordance with an embodiment of the present invention. Scanning system 200 includes a processing system 202 that receives scanned data from a scanner 206 through an interface 204. Processing system 202 includes a processor 208, a system bus 210, and a memory 212. Processing system 202 may be incorporated into scanner 206, with interface 204 serving as an internal interface or bus, or processing system 202 may be part of computer 102 with scanner 206 corresponding to scanner 110 (FIG. 1).

Memory 212 includes scanner software 214, an operating system 216, and application software 218. As an alternative, scanner software 214 may be located on a portable machine-readable medium, such as a compact disk. The compact disk could then be inserted in a compact disk drive, such as shown in FIG. 1, to allow the processor to execute the instructions contained in scanner software 214. Operating system 216 is the master control program for processing system 202, while application software 218 includes a word processing program. Scanner software 214 is the software that operates on the scanned data, as discussed herein. As an example of operation, scanner 206 scans an object and provides the scanned data to processing system 202, which stores the information in memory 212. Processor 208 through system bus 210 can then process the scanned data based on instructions from scanner software 214. After the scanned data is processed, application software 218 can then utilize the processed data to perform word processing tasks.

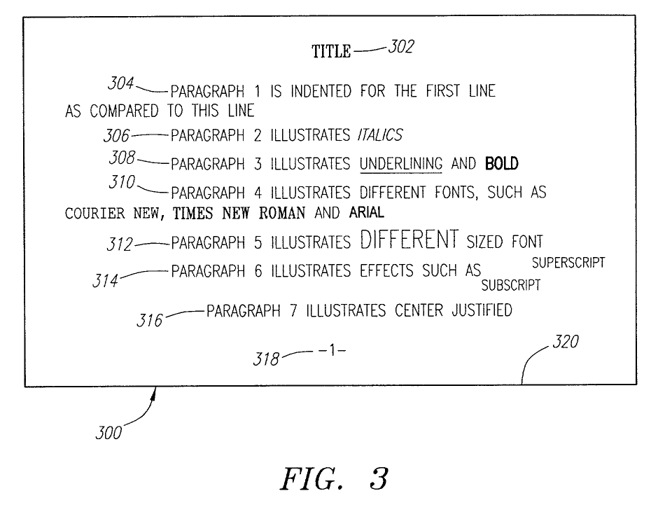

FIG. 3 is an exemplary document 300 illustrating portions of text having various styles, in accordance with an embodiment of the present invention. Document 300 is a representative object that is scanned by scanner 110 or scanner 206 and is provided to illustrate various style characteristics. Style or style characteristics define all of the features that determine how text and graphics appear on an object, such as document 300.

For example, style includes the formatting features generally found in various word processing programs, such as font, font style, font size, effects, line numbering, paragraph structure, tables, and border. Font includes the various font types, such as Arial, Courier, and Times New Roman. Font style defines whether the particular font is in bold, italics, or underlined (e.g., single, double, or dashed underlined). Font size defines the size of the font, such as in number of points, where a point is a unit of measure used to measure the vertical height of a printed character and is equal to 1/72^{nd} of an inch. For example, the font size in points includes 8, 10, 12, and 14-point font. Effects include strikethrough, superscript, subscript, and shadow.

The paragraph structure includes style features, such as indentation, spacing, text alignment, margins, and tabs. Text alignment includes left, center, and right justified. Spacing includes line spacing, such as single or double-spaced lines.

Document 300 illustrates various style characteristics that may be present in a typical document. Elements 302 through 318 identify representative text, such as, for example, the first line of a paragraph, with examples of various style characteristics. Element 302 illustrates a title that is center justified, with a font of Courier New, font size of 12-point, and the characters all capitalized and in bold. Element 304 is the first paragraph of document 300, with the first line shown as being indented relative to the second line of element 304. The text of element 304 has a font of Courier New and a 12-point font size. Element 306 is the second paragraph, with a similar style as element 304, but with the last word (i.e., the word “italics”) of element 306 having a font style of italics. Element 308 is the third paragraph, which illustrates the font styles of underline (i.e., the word “underlining” is underlined) and bold (i.e., the word “bold” is in bold).

Element 310 is the fourth paragraph of document 300 and illustrates different font types. The font types illustrated are Courier New, Times New Roman, and Arial, which are applied respectively to the words “Courier New,” “Times New Roman,” and “Arial” in element 310. Element 312 is the fifth paragraph and illustrates various font sizes. The word “different” is in 16-point font and the word “sized” is in 10-point font, with the remaining words in 12-point font, all having Courier New font. Element 314 is the sixth paragraph and illustrates effects, such as subscript and superscript, which are respectively illustrated by the corresponding words “subscript” and “superscript” in element 314. Element 316 is the seventh paragraph and illustrates text that is center justified. Element 318 illustrates page numbering and element 320 provides a border that surrounds the text, represented by elements 302 through 318.

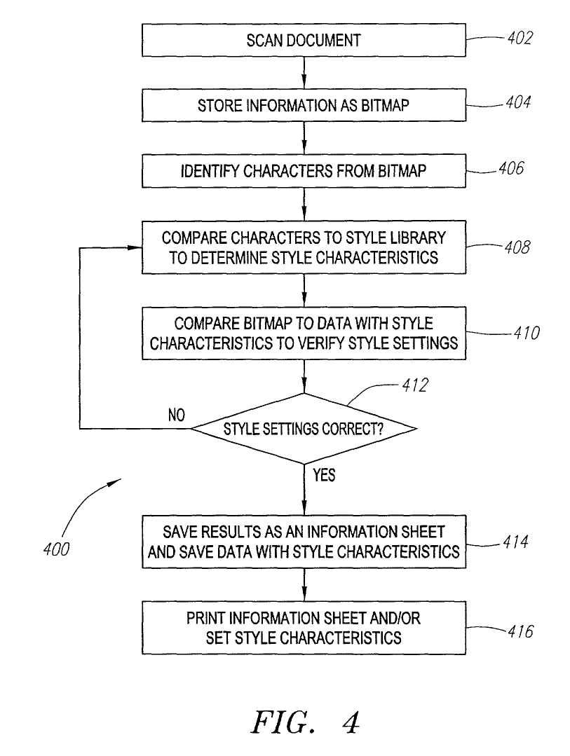

FIG. 4 is a flowchart 400 illustrating the steps for scanning data and recognizing text and style characteristics, in accordance with an embodiment of the present invention. For example, one or more of these steps are performed by scanner software 214 (FIG. 2). Step 402 scans an object, such as a document, to read or photograph the object. The scanning may be performed, for example, with scanner 206 (FIG. 2). Step 404 converts the scanned information into a graphics image (i.e., bitmap) for processing and stores the bitmap in memory. For example, scanner 206 may provide the bitmap information to processing system 202, which stores the bitmap information in memory 212.

Step 406 processes the bitmap information stored in memory to identify text. For example, scanner software 214 employs optical character recognition techniques to sort through the bitmap data and identify characters and text. As an example, U.S. Pat. No. 5,583,949, which is incorporated herein by reference in its entirety, discusses optical character recognition techniques. Once the textual characters (i.e., individual textual alphabetic letters or numeric digits) are identified, step 408 compares these characters to a style library to determine the style characteristics for each character identified.

For example, the style library contains templates of each style characteristic, which are used to determine the best match for each style characteristic that is desired. For example, to select the correct font, statistical techniques may be employed to determine the font that is the best match to the scanned data, such as when more than one font closely corresponds to the scanned data. Additionally, unique characters may be identified for each font set, with these unique characters used to determine the font of the scanned data or portion of scanned data.

For each character identified, a comparison to style characteristic templates in a certain order may be made to ascertain each particular style characteristic for that character. As an example, font size is determined first, followed by font, and font style. Additional style characteristics determined may further include effects and paragraph structure by comparison to style characteristic templates.

For font size, size templates are employed to determine for the particular character its point size by comparing the character to the size templates to find the best match. The templates may include bitmapped fonts for each typeface design and size for each font style or a font scaler, which converts fonts into bitmaps, may be employed so that each size for each font does not have to be stored.

Next, font templates for each font type are compared to the character to find the most similar font. Similarly, templates for font style and effects are compared to the character to determine these style characteristics. Finally, paragraph structure templates are used to identify style characteristics for each paragraph.

Step 410 makes a final comparison of the original bitmap data to the data that includes the identified style characteristics. If the comparison is favorable (step 412), the style settings are verified. Otherwise, step 408 may be repeated or default settings utilized.

Step 414 saves the processed data with the identified style characteristics and also prepares an information sheet. For example, the information sheet is a style sheet, which is a master page layout used in word processing. The style sheet stores margins, tabs, fonts, headers, footers, and other layout settings for a particular category of document. As an example, when a style sheet is selected in a word processing program, its format settings are applied to the document created under it, such that the user does not have to manually set the same settings repeatedly for each document or section within a document.

Step 416 prints the information sheet, such as with printer 124 (FIG. 1), and also sets the style characteristics in the format required by the desired word processing program, such as contained in application software 218 (FIG. 2). For example, the information sheet could be used to convert the scanned data with the determined style characteristics into formatted text readable by the word processing program. Formatted text includes the text and codes for the style characteristics of the text.

Thus, style characteristics of scanned data in bitmap form are determined. Furthermore, these style characteristics can be applied within a word processing program to allow the insertion of additional text to the scanned data. The additional text will have the same style characteristics as the information that was scanned, without requiring the user to manually determine and select these style characteristics within the word processing program.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method of determining style characteristics from scanned data, the method comprising:
identifying characters within the scanned data;
comparing the characters to a style library containing templates of each style characteristic to determine the style characteristics for each character; and
saving the scanned data as processed data containing style characteristics of the scanned data.

2. The method of claim 1, further comprising preparing an information sheet containing the style characteristics of the scanned data and printing the information sheet.

3. The method of claim 1, further comprising setting the style characteristics in a format such that the processed data containing the style characteristics is readable by a word processing program.

4. The method of claim 1, wherein the comparison of the characters to a style library includes templates for font size, font, font style, effects, or paragraph structure.

5. The method of claim 1, wherein the comparison of the characters to a style library containing templates is performed in the style characteristic order of font size, font, and font style.

6. A computer system for processing scanned data, the computer system comprising:
a processor;
a memory, coupled to the processor, storing instructions that are executed by the processor to perform a method of processing the scanned data, the method comprising:
identifying characters within the scanned data;
comparing the characters to templates of each style characteristic to determine style characteristics for each character; and
saving in the memory the scanned data as processed data containing the style characteristics of the scanned data.

7. The computer system of claim 6, further comprising a scanner coupled to the processor and adapted to provide the scanned data.

8. The computer system of claim 6, further comprising a printer coupled to the processor, and wherein the method further comprises preparing an information sheet containing the style characteristics of the scanned data, which is printable by the printer.

9. The computer system of claim 6, wherein the method further comprises setting the style characteristics in a format such that the processed data containing the style characteristics is readable by a word processing program.

10. The computer system of claim 6, wherein the method for comparing the characters to templates of each style characteristic is performed in the style characteristic order of font size, font, and font style.

11. A machine-readable medium for use in a computer system having a processor for processing scanned data, the medium having instructions that are executed by the processor to perform a method of processing the scanned data, the method comprising:
identifying characters within the scanned data;
comparing the characters to templates of each style characteristic to determine style characteristics for each character; and
saving the scanned data as processed data containing the style characteristics of the scanned data.

12. The machine-readable medium of claim 11, wherein the method further comprises preparing an information sheet containing the style characteristics of the scanned data.

13. The machine-readable medium of claim 11, wherein the method further comprises setting the style characteristics in a format such that the processed data containing the style characteristics is readable by a word processing program.

14. The machine-readable medium of claim 11, wherein the method further comprises comparing the templates in the style characteristic order of font size, font, and font style.
